(19) United States
(12) Patent Application Publication
(10) Pub. No.: US 2004/0054543 A1
(43) Pub. Date: Mar. 18, 2004

(54) Storage and management method for a multi-floor stocker system

(76) Inventors: Chiao-Ling Lin, Taichung City (TW); Kai-Chi Lin, Hsinchu (TW)

Correspondence Address: BIRCH STEWART KOLASCH & BIRCH, PO BOX 747, FALLS CHURCH, VA, 22040-0747, US

(21) Appl. No.: 10/230,062

(22) Filed: Aug. 29, 2002

(51) Int. Cl. G06F 17/60

(52) U.S. Cl. 705/1; 700/113; 700/214

(57) ABSTRACT

A storage and management method for a multi-floor stocker system. The storage and management method combines a pull function and a push function with a from-to table to optimally distributed lots of work-in-process (WIP) to all stockers in the multi-floor system, thereby effectively utilizing every stocker. The from-to table is established by the following steps: evaluation of a step process time and a step equipment number; calculation of a step work ability for every stage based on the step process time and step equipment number of every product; and summary of the step work ability for every stage and production of a from-to table.

### BACKGROUND OF THE INVENTION

1. Field of the Invention

This invention relates to a storage and management method for a multi-floor stocker system, which combines push and pull functions and table-oriented delivery management to optimally distribute lots of work-in-process (WIP) to all stockers in the multi-floor system, thereby effectively utilizing every stocker.

2. Description of the Related Art

Currently, automated storage/retrieval is a must in wafer industries. For a wafer processing manufacturer, multi-floor stocker structure is widely employed in automated storage/retrieval to save required space and increase managing efficiency for WIP. Configuration of equipment and production flow usually collects identical or similar machine(s) in the same tunnel. Thus, multiple tunnels with different processing equipment are formed. A rail-guided vehicle (RGV) is implemented between tunnels to shuttle loads such as WIP between tunnels for processes such as lithography, etching, diffusion, and film thin processing. However, due to many factors, such as different process time and equipment number, a certain number of WIPs may not be processed as soon arriving at their destination or being shuttled to the next destination after processing. Accordingly, a stocker system is important, especially a multi-floor stocker system for a modern building, to gain the best operation efficiency on very expensive wafer processing equipment. Unfortunately, a storage and management method complying with the multi-floor stocker system has not been provided without additional stocker equipment.

### SUMMARY OF THE INVENTION

Therefore, an object of the invention is to provide a storage and management method for a multi-floor stocker system, which combines push and pull stocking and a table-oriented management scheme to optimally distribute work-in-process (WIP) in the multi-floor stocker system.

Accordingly, the storage and management method for a multi-floor stocker system includes the following steps: checking storage capacities of all floors when a request from a desired lot is received; performing a pull function on the desired lot by a computer command or by hand if the desired lot will be delivered in/out a floor without sufficient storage capacity; and otherwise performing a push function for storing the desired lot according to a predetermined from-to table. The method further includes the steps of determining if a request of an undesired lot comes from a dummy lot or a monitor lot; storing the undesired lot to a preset shelter if the request comes from a dummy lot or a monitor lot; determining if the undesired lot has an assignment on the same floor if the request does not come from a dummy lot or a monitor lot; delivering the undesired lot according to the assignment on the same floor; and otherwise, delivering the undesired lot to a floor with sufficient storage capacity using the push function according to the from-to table.

### BRIEF DESCRIPTION OF THE DRAWINGS

FIG. 1 is a schematic diagram of a multi-floor stocker system according to the invention;

FIG. 2 is a flowchart of a storage and management method complying with the multi-floor stocker system in FIG. 1 according to the invention;

FIG. 3 is a flowchart of a pull function according to the invention;

FIG. 4 is a flowchart of a push function according to the invention;

FIG. 5 is a flowchart of a from-to table establishment method according to the invention;

FIG. 6 is an example of an evaluation table for every product; and

FIG. 7 is an example of the from-to table.

### DETAILED DESCRIPTION OF THE INVENTION

The following similar function elements are denoted by the same reference numerals.

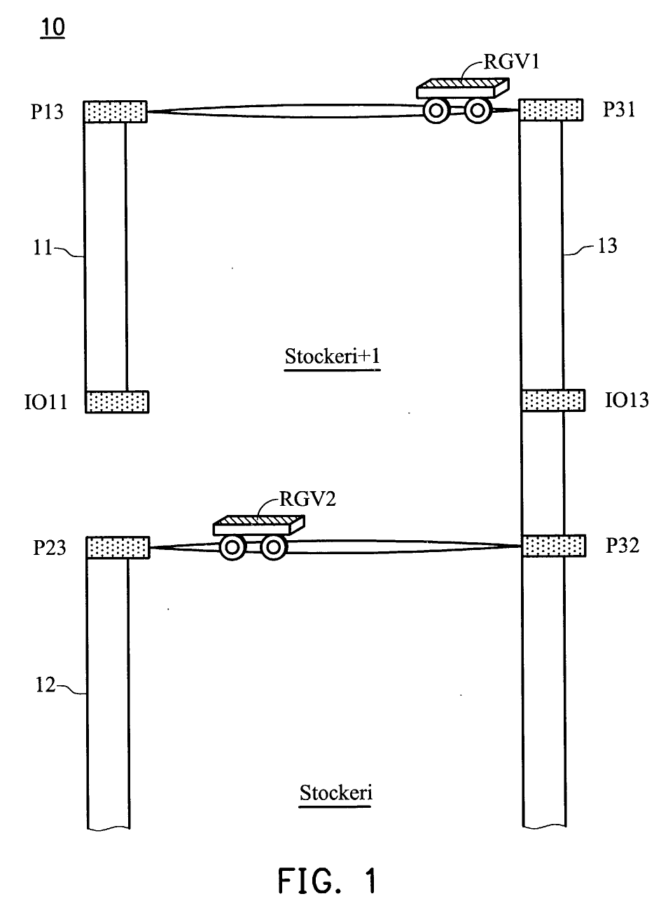

FIG. 1 shows a schematic diagram of a multi-floor stocker system 10 according to the invention. For simple description, FIG. 1 only shows two ports such as P13, P31 or P23, P32 and a robot for each floor (such as stockerᵢ or stockerᵢ₊₁) and an I/O port such as IO11 or IO13 for two adjacent floors (such as stockerᵢ and stockerᵢ₊₁). The ports P13, P31, P23, and P32 are used for lot attachment/detachment and the ports IO11 and IO13 are used for lot storage/retrieval. The robot is responsible from processing a desired lot for any action controlled by a computer with predetermined programming (control logic).

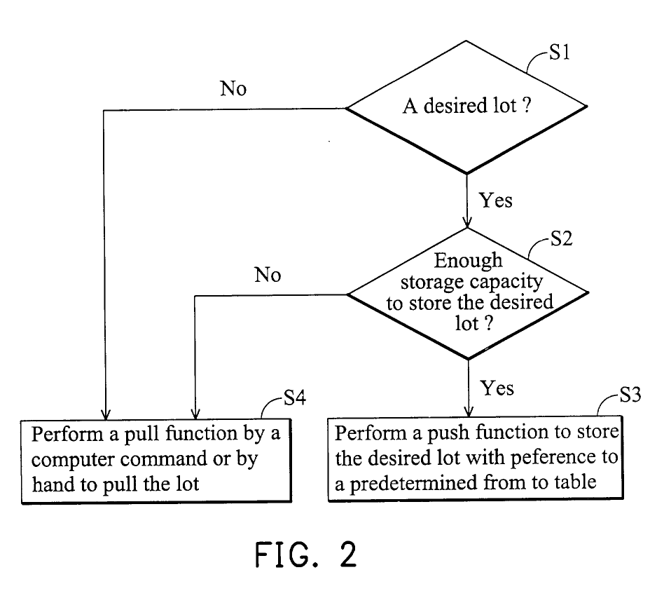

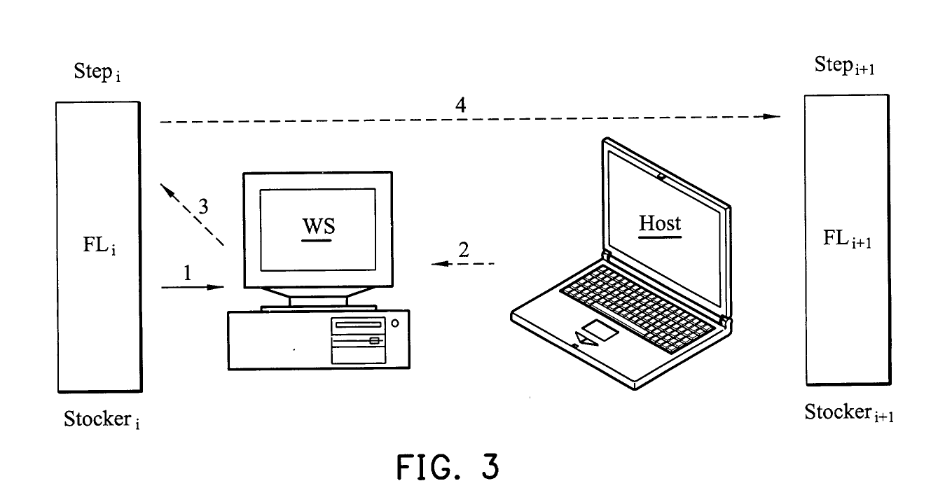

FIG. 2 is a flowchart of a storage and management method complying with the multi-floor stocker system in FIG. 1 according to the invention. As shown in FIG. 2, an auto-delivery system is not always more effective than a manual system, especially in a small factory. For this, in step S1, first determine if a request for delivering and storing a WIP belongs to a desired lot. Next, step S2 further determines if storage capacity for the desired lot is sufficient. Next, in step S3, a push function is performed, according to a predetermined from-to table, to store the desired lot to a stocker in the same or different floor with sufficient storage capacity. Also, in step S4, a pull function is performed by a computer or by hand in order to pull the lot in/out if the request is not from the desired lot (i.e. an undesired lot, which can include dummy lot, monitor lot and hold lot) or the desired lot has been forwarded to a floor without sufficient storage capacity. As cited above, the pull function, the push function and the from-to table are further described in the following drawings.

FIG. 3 is a flowchart of the pull function according to the invention. As shown in FIG. 3, floors FLᵢ and FLᵢ₊₁ are subsequent. The floor FLᵢ has a process station Stepᵢ and a stocker Stockerᵢ. The floor FLᵢ₊₁ has a process station Stepᵢ₊₁ and a stocker Stockerᵢ₊₁. In the pull function, after a desired lot is stored in a stocker and a material control system (not shown) records the address, the storage action is completed. When the lot is not stored in a suitable stocker and has to be moved to another stocker, this can be achieved by receiving a move command from an operator at Stockerᵢ (step 1) or a job prepare preset in a host's GUI (step 2). Thus, a workstation ws can give a command to the floor FLᵢ (step 3) to forward the desired lot to Stockerᵢ₊₁ (step 4). The movement is not automatically completed but is performed only when receiving further instruction. The further instruction is: (1) using a job prepare instruction to forward the desired lot to a destination stocker through an attachment/detachment port and a storage/retrieval port if a desired lot is located in the same process station, and (2) using a move command and assigning a process to store or forward the desired lot to a destination stocker if the desired lot is not located in the same process station.

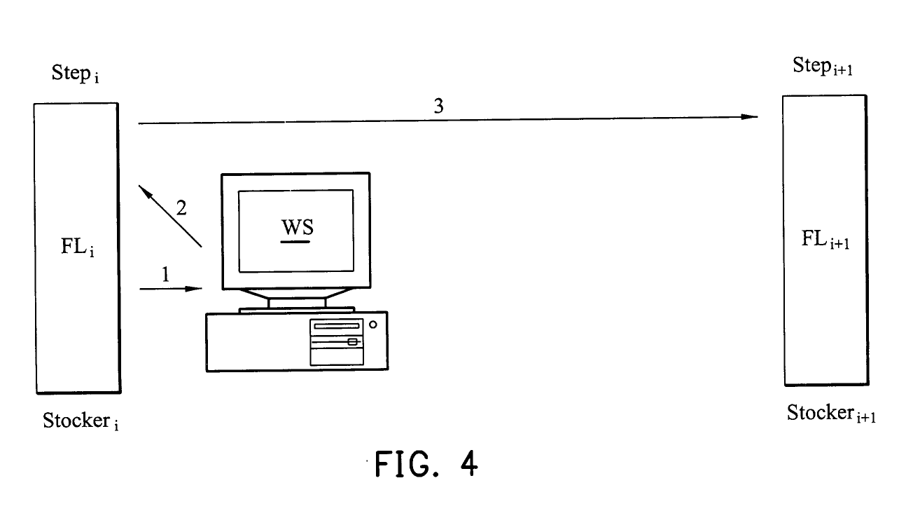

FIG. 4 is a flowchart of the push function according to the invention. As shown in FIG. 4, the main configuration is similar to that of FIG. 3 except for use of the GUI. Instead of a GUI, the push function uses a predetermined from-to table to automatically correct job preparation as need. Thus, when the process station Stepᵢ sends a request to the workstation WS (step 1), the workstation WS can directly give an appropriate instruction with reference to the preinstalled from-to table (step 2). The process station Stepᵢ moves a desired lot from Stockerᵢ to Stockerᵢ₊₁ (step 3) or other processes according to the instruction. As cited above, the design of the from-to table is a key point for the performance efficiency.

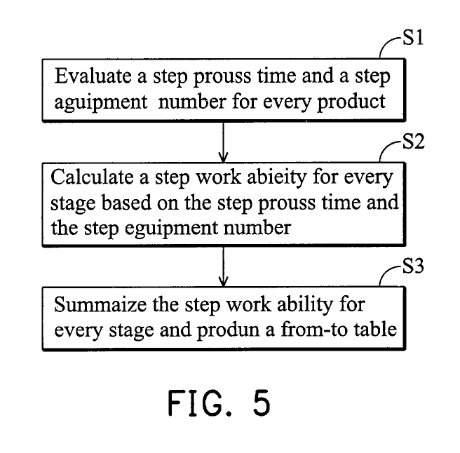

FIG. 5 is a flowchart of a from-to table establishment method according to the invention. As shown in FIG. 5, the from-to table establishment includes three steps: evaluation of a step process time and a step equipment number (S1); calculation of a step work ability for every stage based on the step process time and step equipment number of every product (s2); and summary of the step work ability for every stage and production of a from-to table (S3).

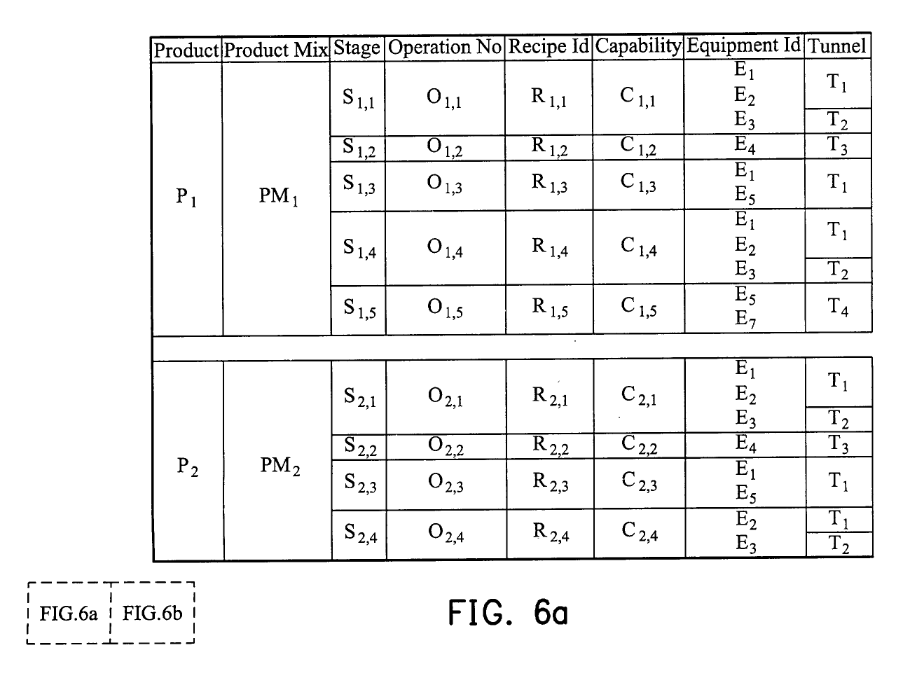

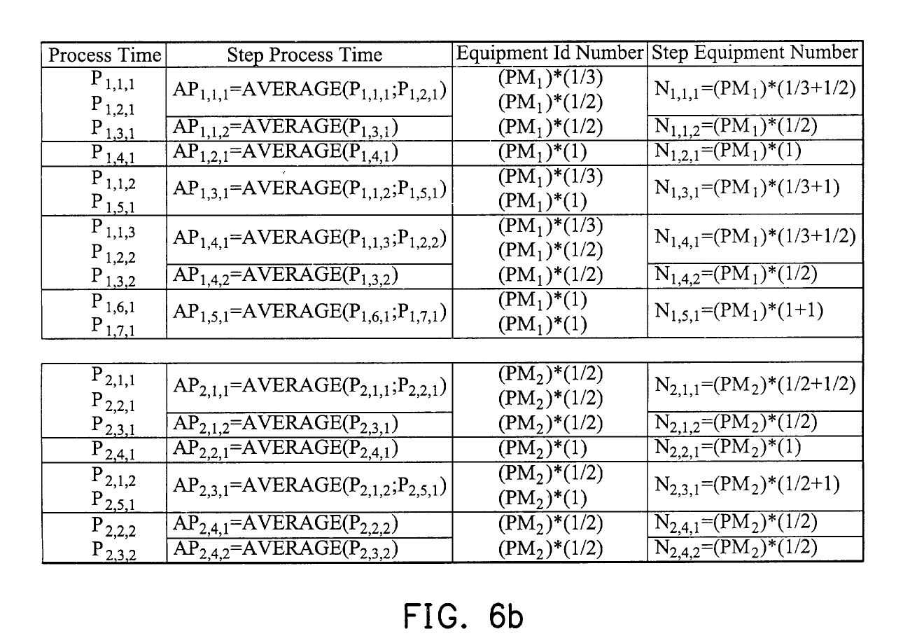

For evaluation of the step process time and the step equipment number, table 1 is given in FIG. 6. In FIG. 6, a product P₁ has five operations O₁-O₅, five recipes R_{1,1}-R_{1,5} and five capabilities C_{1,1}-C_{1,5} with respect to five stages S_{1,1}-S_{1,5}. A product P₂ has four operations O₁-O₄, four recipes R_{1,1}-R_{1,4} and four capabilities C_{1,1}-C_{1,4} with respect to four stages S_{1,1}-S_{1,4}. Every stage has different equipment numbers. For example, in this case, there are totally seven equipment numbers E₁-E₇: E₁-E₃ respectively for S_{1,1}, S_{1,4} and S_{2,1}; E₄ respectively for S_{1,2} and S_{2,2}; E₁, E₅ respectively for S_{1,3} and S_{2,3}; E₆, E₇ for S_{1,5}; and E₂, E₃ for S_{2,4}. Equipment in each stage can respond to a process time and a channel. For example, in this case, equipment E₁ in stage S_{1,1}, corresponds to a process time P_{1,1,1} and a channel T₁ while equipment E₁ in stage S_{1,3} corresponds to a process time P_{1,1,2} and the channel T₁. The process time P_{1,1,1} denotes a first process time of E₁ for P₁ and the process time P_{1,1,2} denotes a second process time of E₁ for P₁. Likewise, process time P_{2,4,1} denotes a first process time of E₄ for P₂ and the remaining are the like. The step process time is defined as the step process time per channel-per operation and evaluated by taking an average for every channel. For example, in channel T₁, step process time AP_{1,1,1} equals the average of P_{1,1,1} and P_{1,2,1}. Moreover, in channel T₂, step process time AP_{1,1,2} equals the average of P_{1,3,1}. The remaining step process time is the same. Additionally, equipment can be used at different stages for a product. For example, for P₁, E₁ is used at operations O_{1,1}, O_{1,3}, O_{1,4} and E₂ is used at operations O_{1,1}, O_{1,4}. Thus, for each operation in P₁, the utility probability is 1/3 for E₁ and 1/2 for E₂. The equipment Id number defining the real equipment number used by per stage-per product is product mix PM₁ multiplying (1/3) for E₁ and product mix PM₁ multiplied by 1/2 for E₂. PM₁ is the ratio of the amount of P₁ to the total amount of all products. Likewise, PM₂ is the ratio of the amount of P₂ to the total amount of all products. In this case, therefore, PM₁+PM₂=1. However, it can be more than two products. As such, the sum of all product mixes should be 1. The step equipment number such as N_{1,1,1} is PM₁ multiplying (⅓+½). The remaining step equipment numbers are obtained in the same manner. The result evaluated for the step process time and the step equipment number is listed in a table as shown in FIG. 6. Accordingly, step work ability can be calculated by taking the ratio of step process time to step equipment number in each channel (S2 in FIG. 5) and the step work ability for every stage is summarized in a table (S3 in FIG. 5).

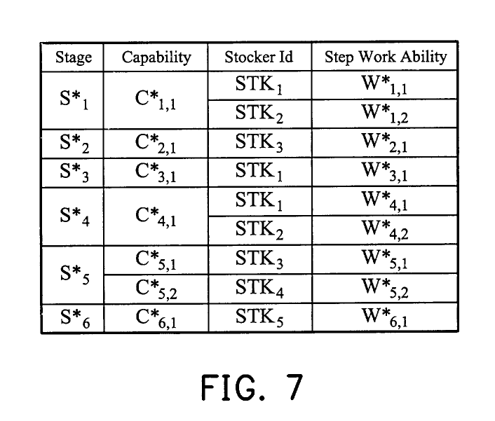

Therefore, a from-to table as shown in FIG. 7 is established. In FIG. 7, the value of step work ability becomes low with high work ability and high turn rate. High turn rate means less WIP to be stacked. With reference to the from-to table, when an operation on a desired lot is completed and the desired lot is stored in a stocker, the system sends the desired lot to an assigned stocker according to its stage and capability of next operation. A tunnel corresponds to the stocker (stocker Id) most convenient for storage/retrieval. Because the same or similar functional equipment may be disposed in different tunnels or even different floors, a stage and capability may be mapped to more than one stocker, for example, (S*₁, C*_{1,1}) to (STK₁, STK₂) and (S*₄, C*_{4,1}) to (STK₁, STK₂). An example of determination to store the desired lot in STK₁ or STK₂ is given under the condition of S*₁ and C*_{1,1}. If WIP*ᵢ is the current WIP amount in STKᵢ, and W*ᵢ is the work ability of STKᵢ, and STK₁ is a default stocker, wherein i is 1 or 2, the delivery logic is:

If (WIP*₁/W*₁) (WIP*₂/W*₂), the desired lot is sent to STK₁.

If (WIP*₁/W*₁)>(WIP*₂/W*₂), the desired lot is sent to STK₂.

Further, a high water mark (HWM) is used to preserve a buffer region in a stocker to buffer a processed lot to be forwarded to next operation or to indicate a desired lot to be processed temporarily stored to an alternate stocker until a low water mark (LWM) is signaled to release the HWM. When the HWM is released by the LWM, the desired lot to be processed is sent back from the alternate stocker to the stocker and operated as usual.

To summarize above, the invention provides a storage and management method for a multi-floor stocker system, which combines push and pull function and a from-to table to optimally distribute lots of work-in-process (WIP) to all stockers in the multi-floor system, thereby effectively utilizing every stocker.

Although the invention has been described in its preferred embodiment, it is not intended to limit the invention to the precise embodiment disclosed herein. Those who are skilled in this technology can still make various alterations and modifications without departing from the scope and spirit of this invention. Therefore, the scope of the invention shall be defined and protected by the following claims and their equivalents.

What is claimed is:

1. A storage and management method for a multi-floor stocker system, comprising the steps:
checking storage capacities of all floors when a request from a desired lot is received, wherein the desired lot is work-in-process (WIP);
performing a pull function on the desired lot when the desired lot will be delivered to/from a floor without sufficient storage capacity; and
performing a push function to store the desired lot according to a predetermined from-to table when the desired lot will be delivered in/out a floor with sufficient storage capacity.

2. The storage and management method of claim 1, wherein the pull function is executed by hand.

3. The storage and management method of claim 1, wherein the pull function is executed by computer command.

4. The storage and management method of claim 1, wherein the from-to table is produced by the following steps:
evaluation of a step process time and a step equipment number;
calculation of a step work ability for every stage based on the step process time and step equipment number of every product; and
summary of the step work ability for every stage and production of a from-to table.

5. The storage and management method of claim 4, wherein the step process time is an average of equipment process time in a channel.

6. The storage and management method of claim 4, wherein the step equipment number is a sum of the utility probability of all equipment in a channel for a product multiplying a ratio of the product's amount to the total amount.

7. The storage and management method of claim 4, wherein the step work ability is a ratio of the step process time to the step equipment number.

8. The storage and management method of claim 1, further comprising a step of determining a delivery stocker if there is a stage with a plurality of stockers in the from-to table.

9. The storage and management method of claim 8, wherein the delivery stocker has the smallest value when a quotient of every stocker's current WIP amount divided by step work ability based on the same stage and capacity is evaluated.

10. A storage and management method for a multi-floor stocker system, comprising the steps:
determining if a delivery request comes from a desired lot;
performing a pull function for pulling a lot from the delivery request when the delivery request does not come from the desired lot, wherein the lot includes dummy lot, monitor lot, and hold lot;
checking storage capacities of all floors wherein work-in-process (WIP) is the desired lot when the delivery request comes from the desired lot;
performing a pull function for pulling the lot when the desired lot will be delivered in/out a floor without sufficient storage capacity; and
performing a push function for storing the desired lot according to a predetermined from-to table when the desired lot will be delivered in/out a floor with sufficient storage capacity.

11. The storage and management method of claim 10, wherein the pull function is executed by hand.

12. The storage and management method of claim 10, wherein the pull function is executed by computer command.

13. The storage and management method of claim 10, wherein the from-to table is produced by the following steps:
evaluation of a step process time and a step equipment number;
calculation of a step work ability for every stage based on the step process time and step equipment number of every product; and
summary of the step work ability for every stage and produce a from-to table.

14. The storage and management method of claim 13, wherein the step process time is an average of equipment process time in a channel.

15. The storage and management method of claim 13, wherein the step equipment number is a sum of the utility probability of every item of equipment in a channel for a product multiplying a ratio of the product's amount to the total amount.

16. The storage and management method of claim 13, wherein the step work ability is a ratio of the step process time to the step equipment number.

17. The storage and management method of claim 10, further comprising a step of determining a delivery stocker if a stage with a plurality of stockers in the from-to table.

18. The storage and management method of claim 17, wherein the delivery stocker has the smallest value when evaluation of every stocker's current WIP amount is divided by step work ability based on the same stage and capacity.
